(19) United States
(12) Patent Application Publication
(10) Pub. No.: US 2005/0016215 A1
(43) Pub. Date: Jan. 27, 2005

(54) Apparatus for supporting a glass body and manufacturing method for making same

(76) Inventors: Norbert Greulich-Hickmann, Mainz (DE); Andreas Langsdorf, Ingelheim (DE)

Correspondence Address: STRIKER, STRIKER & STENBY, 103 East Neck Road, Huntington, NY, 11743, US

(21) Appl. No.: 10/886,338

(22) Filed: Jul. 7, 2004

(30) Foreign Application Priority Data
Jul. 21, 2003 (DE) 103 33 041.0

(51) Int. Cl. C03B 40/04

(52) U.S. Cl. 65/182.2; 264/629; 264/643; 65/374.15; 264/29.2

(57) ABSTRACT

The apparatus for supporting a glass body is made by a method including the following steps: putting carbon-containing fibers in an axially parallel arrangement and tightly packing them; twisting the resulting tightly packed carbon-containing fiber bundle to form a carbon-containing fiber rope piece and fixing it in a twisted state; then pyrolyzing the resulting carbon-containing fiber rope piece, soaking the pyrolyzed carbon-containing fiber rope piece in a silicon-containing fluid and ceramicizing the carbon-containing fiber rope piece. The supporting apparatus formed by this method includes a gas-permeable body, which has channels or passages through which a gas, such as air, can pass. The channels are inclined at their outlet ends on a gas outlet surface of the gas-permeable body.

### BACKGROUND OF THE INVENTION

1. Field of the Invention

The present invention relates to a manufacturing method for making an apparatus for support of a glass body and to the supporting apparatus manufactured thereby.

2. Description of the Related Art

Supporting a glass body by floating it on an air cushion is known, for example from JP 2000 154 027 and JP 200 095 531. JP 2000154 027 and JP 200 095 531 disclose an apparatus for molding or forming glass, in which the lower mold or die is gas permeable. Pressurized gas flows through the lower mold in the direction of the glass body being formed, whereby it is held spaced from the lower mold in a floating state.

In order to guarantee the rotational symmetry of the glass body made in this way, different solutions are called for in the literature.

JP 82 592 42 discloses an apparatus for supporting a glass body on an airbed. The air passes through a plurality of air channels, which are inclined differently in relation to the surface normal of the air outlet surface. In operation the apparatus and thus the channels through which the air passes to act on the glass body rotate about a vertical axis. A revolving airbed results, whose radial force on the glass body leads to its rotationally symmetric formation.

To float a glass body on an air cushion U.S. Pat. No. 3,223,500 provides a supporting body, through which the air passes in a number of channels arranged in a plane. The channel plane is rotated so that the air is put into a whirling state so that the glass part is floated on a revolving air cushion.

DE 101 22 593 A1 discloses a supporting apparatus for a glass body, which is made from a wooden body. It uses the fact that wood has channels because of its nature, which remain in pyrolysis. Prior to pyrolysis the wood fibers are mechanically twisted about its longitudinal axis parallel to the fiber direction, so that the air flowing out from the pyrolyzed wood body has a flow direction, which is inclined to the gas outlet surface. Because of that the glass body is held on a rotating gas bed. In practice it has been shown that only supporting bodies with a small diameter can be provided with this method, since the mechanical forces for twisting the wood fibers increase greatly with increasing diameter. The twisting of the wood semi-finished body frequently causes tearing, which can result in an ineffective supporting body.

### SUMMARY OF THE INVENTION

It is an object of the present invention to provide an improved manufacturing method for an apparatus for supporting a glass body, which requires minimal effort and leads to a supporting body, whose gas permeability is predetermined.

It is another object of the present invention to provide an improved apparatus for supporting a glass body, comprising a gas permeable supporting body having an arbitrarily large diameter and gas outlet surface.

According to the invention the method for manufacturing an apparatus for supporting a glass body comprises the steps of:
a) putting a plurality of carbon-containing fibers into an axially parallel arrangement and tightly packing them to form a tightly packed carbon-containing fiber bundle;
b) twisting the tightly packed carbon-containing fiber bundle to form a carbon-containing fiber rope piece in a twisted configuration;
c) fixing the carbon-containing fiber rope piece in the twisted configuration;
d) pyrolyzing the twisted carbon-containing fiber rope piece to form a pyrolyzed carbon-containing fiber rope piece;
e) putting the pyrolyzed carbon-containing fiber rope piece into a silicon-containing fluid; and
f) ceramicizing the carbon-containing fiber rope piece.

### DESCRIPTION OF THE PREFERRED EMBODIMENTS

The method that attains the object of the present invention thus comprises a first step in which a plurality of carbon-containing fibers are put in an axial parallel arrangement and tightly packed by lateral forces to form a tightly packed bundle of fibers. In this way a carbon-containing fiber bundle or web is produced. In spite of the mechanical contact between the tightly packed carbon-containing fibers there are empty intervening spaces between them, which form air channels or air passages in the subsequently formed product.

Subsequently the carbon-containing fiber bundle is twisted to form a carbon-containing fiber rope piece. For this purpose the carbon-containing fiber bundle can be clamped at one end and twisted at its other end by an applied torque. Because of the twisting the air channels or passages are inclined at their outlet ends on the air outlet plane. Subsequently it is fixed in its twisted state.

The carbon-containing fiber rope piece is pyrolyzed and the air channels or passages between the carbon-containing fibers are maintained during pyrolysis. For this purpose fibers, which contain sufficient carbon, are chemically bonded with each other. For example, cellulose, hemp or polyester fibers are satisfactory for this purpose as the carbon-containing fibers.

Then the pyrolyzed carbon-containing fiber rope piece is exposed to a silicon-containing fluid for a predetermined time interval. Gaseous silicon, silicon monoxide or organic silicon compounds in gaseous form can be used for this purpose. Alternatively the carbon-containing fiber rope piece can be soaked in a silicon-containing solution and subsequently dried.

Next the soaked carbon-containing fiber rope piece is ceramicized. The silicon soaked into the fiber rope piece or strand reacts totally or partially with the free carbon formed during the pyrolysis step to form silicon carbide or forms other silicon compounds, for example silicon oxides or silicon nitrides.

The supporting body formed thereby has air passages or channels inclined to the air outlet surface or plane, which is perpendicular to the axis about which the carbon-containing fibers are twisted.

When a gas passes through the passages or channels of the supporting body and leaves it inclined to the air outlet surface, a revolving rotationally symmetric gas bed is produced. The rotationally symmetric gas bed or airbed not only keeps a sufficiently heated and thus formed glass gob floating, but also shapes or forms a rotationally symmetric body.

A porous supporting body, whose gas permeability is determined by selection of or by the selected fiber diameter, is produced by the described procedure. When only one fiber diameter is used, the permeability increases with increasing fiber diameter.

Generally the force for keeping the glass body on the air or gas cushion depends on the applied gas pressure and on the permeability of the supporting body. At constant gas pressure the holding force can be adjusted by selection of the respective fiber diameters for making the supporting body.

The described method permits preparation of supporting bodies with large diameter or large gas outlet surfaces. For example, this permits keeping so-called glass gobs, even gobs with a large diameter, for example of more than 2 cm, floating on a gas floatation bed, during manufacture of rotationally symmetric optical elements, such as lenses from glass bodies.

Gases, for example air and noble gases, such as helium, can be used for preparation of this sort of gas floatation bed.

In a preferred embodiment of the above-described method carbon-containing fibers with different diameters can be used. The permeability can be adjusted variably in this way and thus the force acting on the gob can be precisely adjusted.

To make the gas permeable supporting body natural fibers, for example hemp, sisal, wool and silk, can be used. On the other hand, artificial or synthetic fibers, such as polyester, are preferred, because they have a reproducible diameter. The advantageous constant channel or pore diameter and thus a more constant permeability of the supporting body depend on this latter reproducibility. Furthermore synthetic fibers are typically longer than natural fibers, so that it is possible to make more supporting bodies from a single fiber rope section.

In a preferred embodiment the gas permeable supporting body is made from fibers with a fiber diameter in a range of from 20 μm to 200 μm. Gobs of about 10 mm diameter can be floated with this embodiment.

The supporting apparatus according to the invention comprises an apparatus for supporting a glass body, which is made by the above-described method. The supporting apparatus comprises the gas permeable supporting body provided with channels or passages with an interior diameter of 0.1 to 200 μm, preferably from 1 to 20 μm. It is possible with these dimensions to keep gobs floating with diameters of 10 mm.

In a preferred embodiment the supporting body can be mounted rotationally fixed in operation. No rotation apparatus is thus required, which rotates the supporting body, which reduces the apparatus expense.

### BRIEF DESCRIPTION OF THE SEVERAL VIEWS OF THE DRAWING

The objects, features and advantages of the invention will now be illustrated in more detail with the aid of the following description of the preferred embodiments, with reference to the accompanying figures in which:

FIG. 1 is a perspective view of the supporting apparatus for supporting a glass body, shown in operation supporting a glass gob on a gas cushion;

FIG. 2 is a top plan view of the supporting body of the supporting apparatus showing the gas outlet openings;

FIGS. 3a, 3b, 3c, 3d and 3e are respective views showing steps of a method of making the gas permeable supporting body shown in FIG. 1.

### DETAILED DESCRIPTION OF THE INVENTION

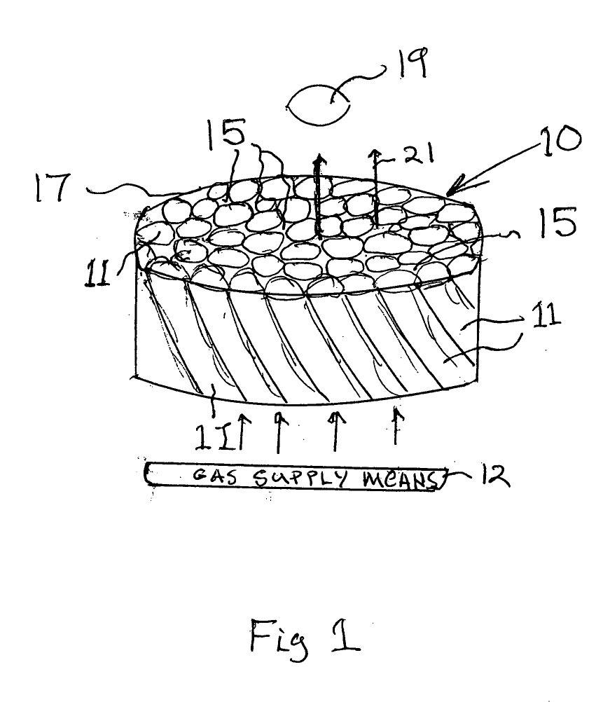

FIG. 1 shows the supporting apparatus for supporting a glass gob 19 in operation. The supporting apparatus includes a gas permeable supporting body 10 comprising a plurality of carbon-containing fibers 11 tightly packed together but with intervening spaces forming channels or passages between them. The supporting body 10 has a gas outlet surface 17. A plurality of gas outlet openings or mouths 15 of the channels or passages between the fibers 11 open onto the gas outlet surface 17. The carbon-containing fibers 11 are twisted about a normal direction perpendicular to the gas outlet surface 17.

A gas supply means 12 feeds a gas, for example air, into the channels or passages on a side of the supporting body 10 opposite from the gas outlet surface 17. Then the gas flows through the channels and out of the gas outlet openings 15 on the surface 17 in a gas flow direction 21. The gas stream leaving the supporting body 10 supports the glass gob 19 on a so-called airbed or air cushion.

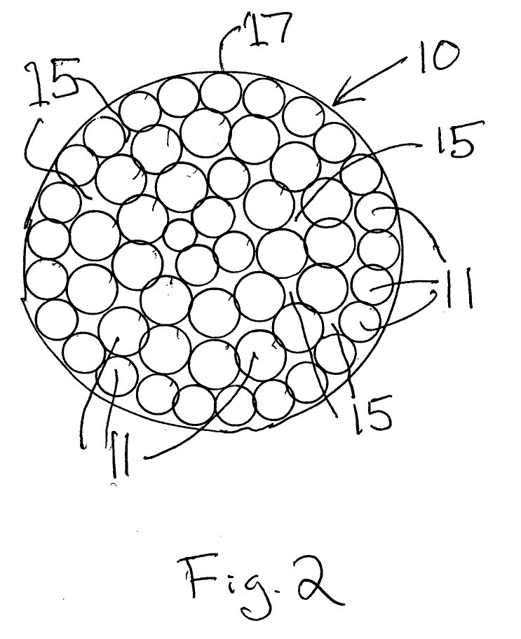

FIG. 2 shows a top plan view of the gas permeable supporting body 10 illustrated in FIG. 1. This view clearly shows that the carbon-containing fibers 11 are of different diameters and the gas outlet openings 15 on the gas outlet surface 17 are of different size.

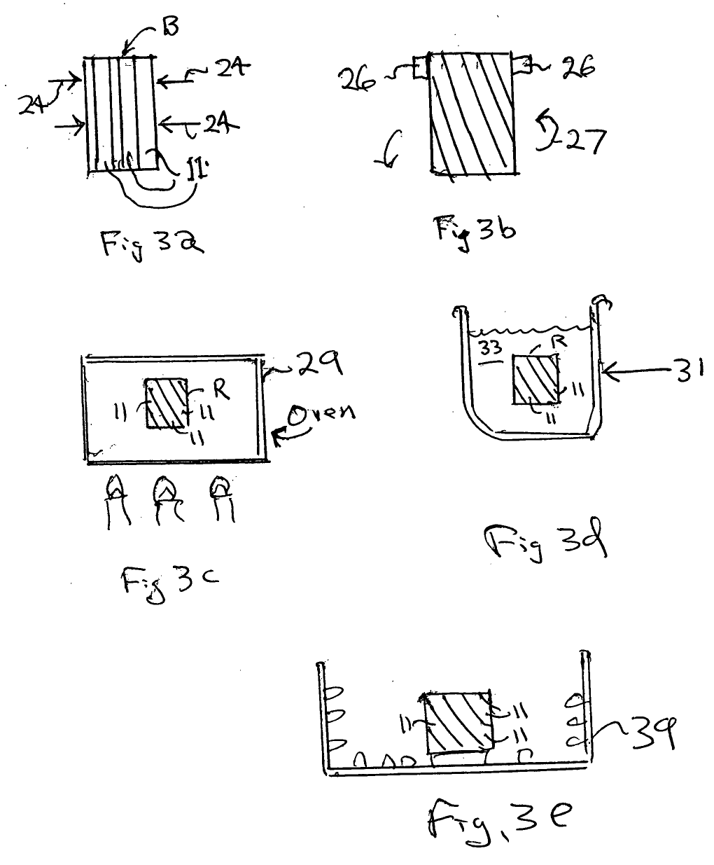

FIG. 3 shows the steps of the method according to the invention for making the supporting body 10. In a first step shown in FIG. 3a a group of carbon-containing fibers 11 are put in an axially parallel arrangement. Then a tightly packed carbon-containing fiber bundle B is formed by tightly packing this group of fibers by applying lateral forces 24. In a second step shown in FIG. 3b a clamping device 26 shown diagrammatically clamps one end of the carbon-containing fiber bundle B to prevent its rotation. Then the opposite end of the fiber bundle B is twisted in the direction of the arrows 27 and the fiber bundle B is fixed in this twisted state to form a twisted fiber rope piece R. Then as shown in FIG. 3c the fiber rope piece R is pyrolyzed in an oven 29 to form a pyrolyzed rope piece. After that the pyrolyzed carbon-containing fiber rope piece R is soaked in a silicon-containing fluid 33 in a vessel 31 in step 3d. Following that it is ceramicized to form silicon carbide in it in the ceramicizing unit 39 as shown in FIG. 3e. This method produces the gas permeable supporting body 10 shown e.g. in FIG. 1.

The carbon-containing fibers 11 are natural or synthetic, for example hemp, sisal, cellulose or polyester. The carbon-containing fibers have a fiber diameter of from 20 μm to 200 μm and the inside diameter of the channels or passages is preferably from 1 to 20 μm.

The disclosure in German Patent Application 103 33 041.0-45 of Jul. 21, 2003 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a supporting apparatus for a glass body and manufacturing method for making same, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

1. A method of manufacturing an apparatus for supporting a glass body, said method comprising the steps of:
a) putting a plurality of carbon-containing fibers in an axially parallel arrangement and tightly packing said carbon-containing fibers to form a tightly packed carbon-containing fiber bundle;
b) twisting the tightly packed carbon-containing fiber bundle to form a twisted carbon-containing fiber rope piece in a twisted state;
c) fixing the twisted carbon-containing fiber rope piece in the twisted state;
d) pyrolyzing the twisted carbon-containing fiber rope piece to form a pyrolyzed carbon-containing fiber rope piece;
e) putting the pyrolyzed carbon-containing fiber rope piece into a silicon-containing fluid; and
f) ceramicizing the carbon-containing fiber rope piece.

2. The method as claimed in claim 1, wherein the carbon-containing fibers have different diameters.

3. The method as claimed in claim 1, wherein the carbon-containing fibers are natural fibers.

4. The method as claimed in claim 3, wherein said natural fibers are selected from the group consisting of hemp fibers, sisal fibers, wool fibers and silk fibers.

5. The method as claimed in claim 1, wherein the carbon-containing fibers are synthetic fibers.

6. The method as claimed in claim 1, wherein the carbon-containing fibers have a fiber diameter of from 20 μm to 200 μm.

7. An apparatus for supporting a glass body, said apparatus comprising a supporting body having a plurality of channels or passages for conducting a gas and for forming a gas cushion adjacent to a gas outlet surface of the supporting body, wherein said apparatus is made by a method comprising the steps of:
a) putting a plurality of carbon-containing fibers in an axially parallel arrangement and tightly packing them to form a tightly packed carbon-containing fiber bundle;
b) twisting the tightly packed carbon-containing fiber bundle to form a twisted carbon-containing fiber rope piece in a twisted state;
c) fixing the twisted carbon-containing fiber rope piece in the twisted state;
d) pyrolysing the twisted carbon-containing fiber rope piece to form a pyrolyzed carbon-containing fiber rope piece;
e) putting the pyrolyzed carbon-containing fiber rope piece into a silicon-containing fluid; and
f) ceramicizing the carbon-containing fiber rope piece.

8. The apparatus as defined in claim 7, wherein said channels have an inside diameter of 0.1 to 100 μm.

9. The apparatus as defined in claim 8, wherein said inside diameter is from 1 to 20 μm.

10. The apparatus as defined in claim 8 or 9, further comprising means for keeping said supporting body fixed during operation to prevent rotation.

11. The method as claimed in claim 8, wherein the carbon-containing fibers have different diameters.

12. The method as claimed in claim 8, wherein the carbon-containing fibers are natural fibers.

13. The method as claimed in claim 12, wherein said natural fibers are selected from the group consisting of hemp fibers, sisal fibers, wool fibers and silk fibers.

14. The method as claimed in claim 8, wherein the carbon-containing fibers are synthetic fibers.
